(19) United States
(12) Patent Application Publication
(10) Pub. No.: US 2007/0009277 A1
(43) Pub. Date: Jan. 11, 2007

(54) System and method for modifying print jobs for differing media

(76) Inventor: Jay R. Shoen, Boiser, ID (US)

Correspondence Address: BRINKS HOFER GILSON & LIONE/MARVELL, P.O. BOX 10395, CHICAGO, IL, 60610, US

(21) Appl. No.: 11/175,516

(22) Filed: Jul. 5, 2005

(51) Int. Cl. G03G 15/00

(52) U.S. Cl. 399/82

(57) ABSTRACT

A system and method for modifying a print job based on an analysis of the media to which the print job is to be printed. In one embodiment, a printer includes a controller operable to receive a signal representing a print job such that the controller is operable to interpret the signal into command signals for printing the print job to media. The printer further includes a media analysis device operable to analyze a characteristic of the media to which the print job is printed. The printer further includes a print job modification component that is coupled to the controller and to the media analysis device such that the print job adjustment component is operable to modify the print job in response to the analysis of the media.

### BACKGROUND OF THE INVENTION

Laser printers and inkjet printers are commonly used in office settings and smaller document production facilities that require small scale and often numerous printing jobs for day-to-day business. Such small scale, quick demand, and non-repetitive document reproductions are not cost effective to be printed using industrial or commercial-enterprise printing machines such as those found at book publishing companies, newspaper outfits, and generally large-scale document production facilities. Laser and inkjet printers have melded into office settings to provide companies with the ability to produce sharp-looking, high-quality documents at a moment's notice.

Some kinds of documents, however, have proven to be difficult to reproduce on laser and inkjet computers. While conventional laser and inkjet printers are well suited to producing documents of printed subject matter or pictures on a typical white sheet of paper, conventional laser and inkjet printers may not be as well suited for producing printed subject matter, artwork, photographs, and the like on media that is colored to begin with. More specifically, laser and inkjet printers are typically designed with a toner or ink color scheme directed to be utilized on paper and other media that is white or close to white. Furthermore, the color schema in which documents are typically created assumes that the printed document will be on white media.

Sometimes, however, the paper or media in which the printer applies ink or toner is a color other than white and such conventional printers are not well suited for producing particular colored text, photographic or artistic effects, and pictures on colored paper or colored media. Additionally, the media may also have further defining characteristics, such as a glossy finish or a transparent cellophane such that the conventional means of printing and creating documents to be printed are not optimal for such media. To gain a better understanding of the printing process with conventional printers, the operation of a conventional laser printer is briefly discussed.

FIG. 1 is a side view diagram of a conventional laser printer 170 that will be used to illustrate the typical workings of a conventional laser printer 170. Although an inkjet printer is not depicted in FIG. 1 or in any other figure, the concepts and limitations of a conventional inkjet printer are similar to those of the conventional laser printer 170.

The conventional laser printer 170 operates on the principle of static electricity. Briefly, by using a laser 184 to create specific patterns of static electricity on a rotating drum 181, print may be applied to a sheet of paper according to the specific pattern created. Thus, by controlling the laser 184 in precise detail, virtually anything can be printed to paper by charging the rotating drum 181 with static electricity. Although the workings of a laser printer 170 in well known in the industry, the laser printing concept is described in more detail below.

The laser printer 170 engages and maneuvers paper through a series of pulleys 192 and a belt 191. When a document is to be printed, the belt 191 engages media 198 (i.e., a sheet of paper) from a paper tray 180 and begins maneuvering the paper toward the rotating drum 181. The rotating drum 181 is then prepared for receiving a pattern of static charge that eventually imparts the charge to the media which then receives toner in a similar manner.

The paper, now having toner applied according to an electrostatic image, passes through a fuser 186 which is typically a pair of heated rollers. As the paper passes through the fuser 186, the loose toner powder melts, fusing with the fibers in the paper to create a printed document. The paper, now a printed document, is then rolled along the belt 191 to the output tray 185.

The laser printer 170 includes a controller 190 that is able to receive data from an outside source, e.g., a computer or a portable media card, and store the data in a printing buffer 192 (sometimes called a print queue) and interprets the data (which corresponds to a document) into an electrostatic image to be imparted by the laser 184. The controller 190 typically communicates with a computer system via standard, well-known protocols such as through parallel communications ports and/or universal serial bus ports.

As was discussed briefly above, a conventional laser printer 170 is not well suited for producing particular colors of text and/or pictures on media 198 that is also colored. Typically, a laser printer 170 uses a mix of four colors of toners to realize every possible color representation that may be printed. These four colored toners typically comprise cyan, magenta, yellow and black. As such, when a document or photo is digitized for representation in a printing format, each point of information within the document or photo comprises a value for each of these toners representing how much toner is required for each point of information. For example, yellow text may comprise a high value of yellow (e.g. 255 out of 255) but very low values for cyan, magenta and black (e.g., 0 out of 255). Inkjet printers operate similarly, and typically also utilize four different color inks: cyan, magenta, yellow and black.

Essentially, color printers work the same way as the conventional printer 170 described above, except that color printers typically repeat the above-described printing process four times—one pass each for toner: cyan, magenta, yellow, and black. By combining these four colors of toner in varying proportions, one can generate the full spectrum of color. There are several different ways of doing this. Some models have four toner and developer units on a rotating wheel such that the printer 170 lays down the electrostatic image for one color and puts that toner unit into position. It may then apply this color to the paper before repeating the process again for the next color. Some printers 170 add all four colors to a plate before placing the image on paper 198. Still other more expensive printers 170 actually have a complete printer unit (i.e., a laser assembly, a drum and a toner system) for each color. The media 198 simply moves past the different drum heads 181, imparting all the colors as if on an assembly line.

Turning back to the example discussed above, yellow text will typically have a proportion of toners that is predominantly yellow. This is because color laser and inkjet printers are able to reproduce colors on a printed document, but doing so assumes the printing media 198 is a white or near-white surface to begin with. As such, if the media used in the printing process is a color, such as yellow, the yellow toner used in the printing process may be less pronounced when finished because the yellow toner tends to blend into the media 198. As a result, the picture or text quality on colored media may be less than on white or near-white paper.

### SUMMARY OF THE INVENTION

An embodiment of the invention is directed to a system and method for modifying a print job based on an analysis of the media to which the print job is to be printed. In one embodiment, a printer includes a controller operable to receive a print job from a computer such that the controller interprets the signal into command signals for printing the print job to media. The printer further includes a media analysis device operable to analyze one or more characteristics of the media to which the print job is printed. The printer also includes a print job modification component that is coupled to the controller and to the media analysis device such that the print job adjustment component is operable to modify the print job in response to the analysis of the media.

With such a printing system, print jobs may be modified to be optimal for the particular media to which these print jobs are printed. For example, if the media is determined to be yellow, then the print job may be modified to be optimal for yellow media, if the media is determined to be magenta, then the print job may be modified to be optimal for magenta media, and so on. Further, the characteristic determined may be a characteristic other than color, such as determining paper quality, reflectivity, card stock, etc.

Such a printing system is advantageous because a print job may be modified to be optimal for the printing media without involving the user of the printing system in the decision-making process. When a print job is sent to a printer, the analysis for optimal printing may be automated such that the print job is adjusted automatically for the determined media. Thus, the resulting printing of the print job will yield a better looking document without need for a user to adjust the print job either initially or in a subsequent printing.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side view diagram of a conventional laser printer that is used to illustrate the typical workings of a conventional laser printer;

FIG. 2 shows a printer having a media analysis device that is able to analyze the media (i.e., the paper) for a characteristic, such as color, and adjust any printing according to the analysis; and

FIG. 3 shows a diagram intended to provide a brief, general illustration of a suitable computing environment in which some embodiments of the invention may be implemented.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

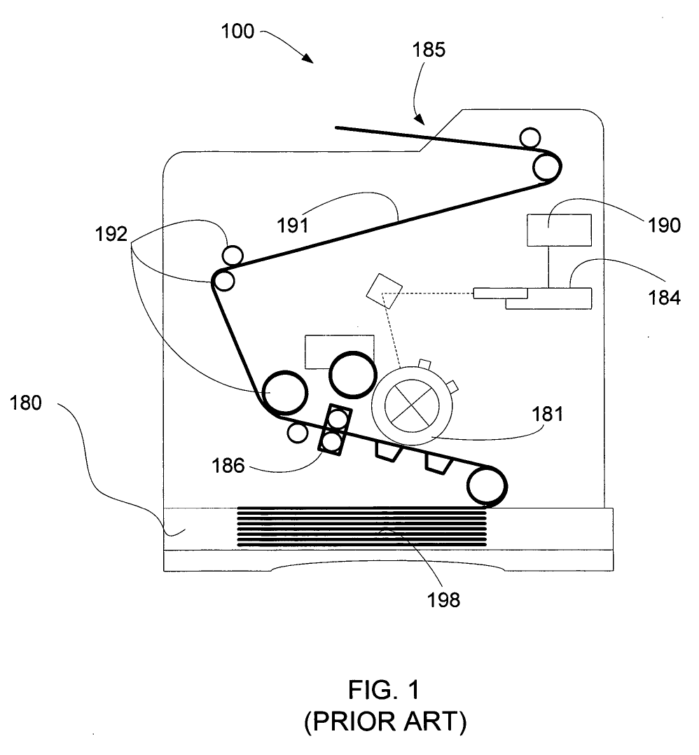

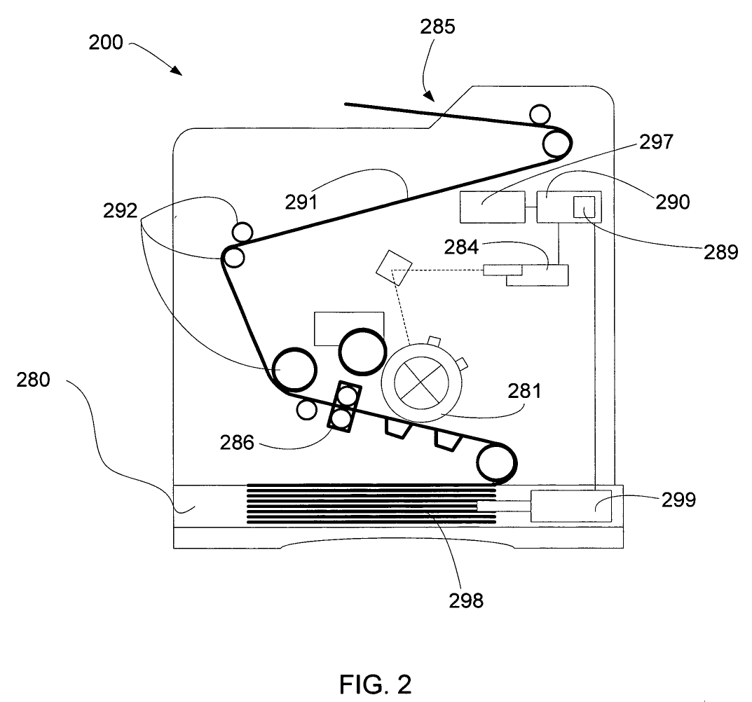

FIG. 2 shows a printer 200 having a media analysis device 299 that is able to analyze the media 298 (i.e., the paper) for a characteristic, such as color, and adjust any printing to the particular media 198 according to the analysis. The printer 200 of FIG. 2 operates similar to the conventional printer 170 described above with respect to the aspects of producing printed pages of text and pictures. The printer 200 is different from the conventional printer 170 of FIG. 1 in that the printer 200 is able to use the media analysis device 299 to analyze a characteristic of the media 298 in which the printer 200 will be printing prior to beginning the actual printing process. In one embodiment, the printer 200 is a laser printer 200; however, one skilled in the art may appreciate that the concepts and descriptions of various embodiments of the invention may be practiced with any suitable printer 200. For the purposes of this disclosure, the printer 200 will discussed throughout in the context of a laser printer.

As was briefly discussed in the background section, by using a laser 284 to create specific patterns of static electricity on a rotating drum 281, print or pictures may be applied to a sheet of paper 298 (or similar printable media) according to the specific pattern created. Thus, by controlling the laser 284, via a controller 290 in precise detail, virtually anything can be printed to paper 298 by charging the rotating drum 281 with static electricity. The laser printer 270 engages and maneuvers paper through a series of pulleys 292 and a belt 291. When a document is to be printed, the belt 291 engages media 298 (i.e., a sheet of paper) from a paper tray 280 and begins maneuvering the paper toward the rotating drum 281. The rotating drum 281 is then prepared for receiving a pattern of static charge that eventually imparts the charge to the media which then receives toner in a similar manner.

The paper 298, now having toner applied according to an electrostatic image, passes through a fuser 286 which is typically a pair of heated rollers. As the paper passes through the fuser 286, the loose toner powder melts, fusing with the fibers in the paper to create a printed document. The paper, now a printed document, is then rolled along the belt 291 to the output tray 285.

The laser printer 270 includes a controller 290 that is able to receive data from an outside source, e.g., a computer or a portable media card, and store the data in a printing buffer 297 and the interpret the data (which corresponds to a document) into an electrostatic image to be imparted by the laser 284. The controller 290 typically communicates with a computer system via standard, well-known protocols such as through parallel communications ports and/or universal serial bus ports. The controller 290 further includes a print job modification component that handles the processing of print job modifications that may result from the analysis of the media.

The media analysis device 299 is coupled to the controller 290 and is able to generate and receive control signals from the controller 290. Typically, the media analysis device 299 may be a calorimeter. A calorimeter is generally any tool that characterizes color samples to provide an objective measure of color characteristics. In specific applications, calorimeters may be used to characterize and correct color response in video monitors. In other applications, calorimeters may be used by photographers to calibrate colors in a photographic print. Colorimeters are also available for disabled people who suffer from blindness or color-blindness, where subjective color names are announced based on objective measurements of color parameters (e.g. hue, saturation and luminance). As used in various embodiments of the invention, a calorimeter may be used to determine various characteristics of the printable media 298.

During a typical printing process, a print job is generated from a device, such as a personal computer (not shown on FIG. 2) and communicated to the printer at the controller 290. A print job typically comprises information about the text and/or pictures to be printed and may be stored in a format compatible with the particular printer 200. Since printer manufacturers are widely varied, the format in which a print job is communicated is also just as widely varied. All print job formats, however, will include information about relative levels of different toners or inks to apply to the printed document.

In a laser printer, typically, the print job may include a value indicative of the relative level of toner to apply for every piece of information about the document to be printed. For a simple black and white (which only uses black toner), the value is indicative of a single relative level of toner to use. However, in color documents, each color (cyan, magenta, yellow, and black) is represented by a value indicative of the relative toner level for each piece of information about the printed document.

In FIG. 2, the printer 200 uses the print buffer 297 for storing print jobs that are waiting to be printed. Thus, when the printer 200 receives a print job from an outside source, the print job is stored in a print buffer 297 until ready to be printed. As discussed in the background section, conventional printers simply print the document if the printer is ready. Quite differently, however, the printer 200 of FIG. 2 first analyzes specific characteristics of the printable media 298 before beginning the printing process as the format of the print job may be adjusted according to the determined characteristics.

As such, the media analysis device 299, may analyze the media 298 that happens to be stored in the media tray 280. Upon analyzing the media 298, the media analysis device 299 may determine a particular characteristic of the media 298 that may be used to modify the printing process. In one embodiment, the characteristic determined is associated with the color of the media 298. Thus, the printing process may be modified to take into account the color of the media 298 to which the printing process is applied. In other embodiments, different characteristics of the media 298 may be analyzed, such as glossiness, paper quality, reflectivity, card stock, etc. Thus, an analysis of the media 298 is used to modify the printing process on the media 298 such that the print job modification component 289 manipulates the format (i.e., the color scheme, such as CMYK) according to the determined characteristics of the media 298.

For example, in order to achieve a better color representation when printing on non-white media, specific levels of specific colored toners may be adjusted based upon the color of the media 298. In the above-described color printing schema, colors of printed text and images are typically created as a blend of four primary colors: cyan, magenta, yellow, and black. For this example, each color may be represented by an 8-bit number between 0 and 255 where 0 indicates a minimum or zero-level of the given color and 255 indicates a maximum wherein the color is fully saturated.

As a simple example of adjusting the print colors to account for the color of the media 298, an original print job may comprise a color scheme made up of the following primary components:

| | |
|---|---|
| CYAN | 163 |
| MAGENTA | 102 |
| YELLOW | 68 |
| BLACK | 5 |

The media analysis device may determine the media to have the following color scheme:

| | |
|---|---|
| CYAN | 0 |
| MAGENTA | 0 |
| YELLOW | 35 |
| BLACK | 0 |

In this example, a simple subtraction schema may be realized by combining the characteristics of the media and the original print job color scheme, yielding a modified print job having an adjusted color scheme comprising:

| | |
|---|---|
| CYAN | 163 |
| MAGENTA | 102 |
| YELLOW | 33 (68 − 35) |
| BLACK | 5 |

Other more sophisticated modifications are also possible. For example, one might wish to deplete or increase the other color channels as well to create the best possible color representation on the example yellow media. Thus, if the media 298 is analyzed to have a high level of yellow, the not only may the yellow component of the print job color scheme be decreased, but the black component of the print job color scheme may also be increased.

Furthermore, the adjustment need not simply be a combinative property, as exponential increases and decreases may be realized as relative color levels of the media approaches the higher limits of the color scales. For example, printing on near black paper, may yield a maximum reduction in the black component value. Additionally, the adjustments may not be as relative as discussed above. Rather, the media analysis device 299 may determine that a threshold value is exceeded for a particular color, thus resulting in a set level adjustment for that color. For example, if the yellow component of the media 298 exceeds a value of 50, then the yellow component of the print job is decreased by 25.

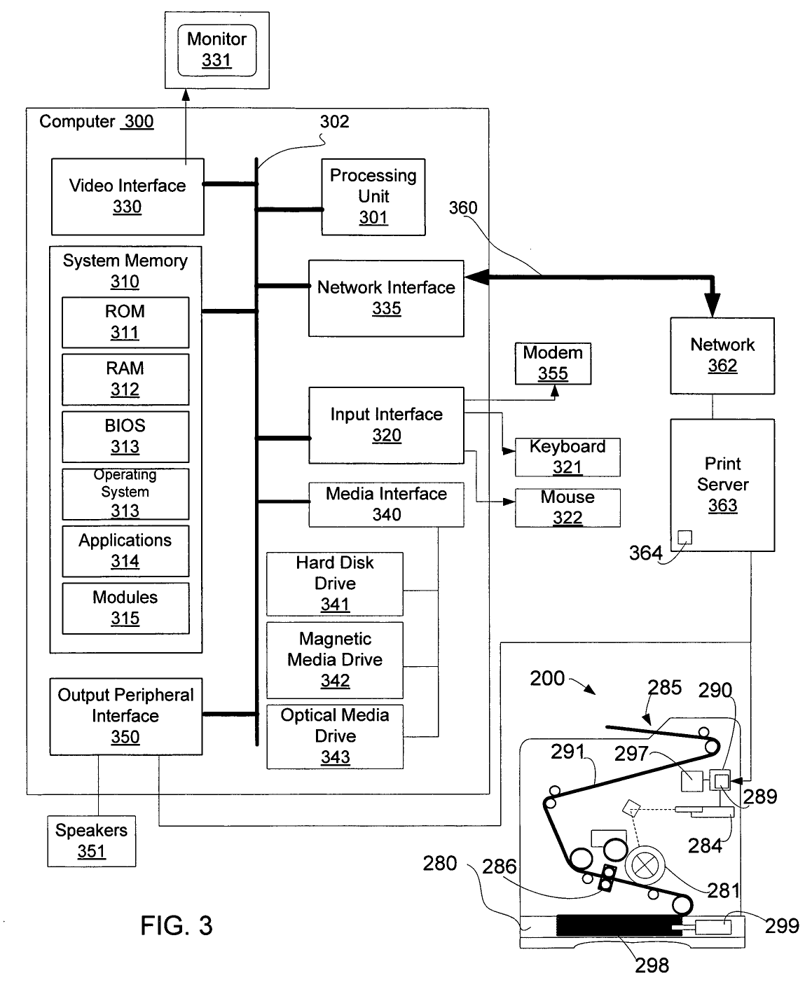

Several possible modification algorithms are contemplated but not discussed herein for brevity. Additionally, the processor that is utilized to modify the print job (the print job modification component 289) may be located outside of the printer 200. These variations are discussed below with respect to FIG. 3.

FIG. 3 and the following discussion are intended to provide a brief, general description of a suitable computing environment in which some embodiments of the invention may be implemented. Generally, printers may be used in conjunction with computer systems in a computing environment that includes program modules including routines, programs, objects, components, data structures, etc. that collectively perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 3, an exemplary system for implementing the invention includes a general purpose computing device in the form of a conventional personal computer 300, including a processing unit 301, a system memory 310, and a system bus 302 that couples various system components including the system memory 310 to the processing unit 301. The system bus 302 may be any of several types of bus structures including a memory bus or memory controller, a peripheral bus, and a local bus using any of a variety of bus architectures. The system memory 310 includes read only memory (ROM) 311 and random access memory (RAM) 312. A basic input/output system (BIOS) 313, containing the basic routines that help to transfer information between elements within the personal computer 300, such as during start-up, is stored in the system memory 310. The system memory 310 may further include program applications 314 and program modules 315.

The personal computer 300 further includes a hard disk drive 341 for reading from and writing to a hard disk (not shown), a magnetic media drive 342 for reading from or writing to a removable magnetic disk (not shown), and an optical media drive 343 for reading from or writing to a removable optical disk (not shown) such as a CD ROM or other optical media. The hard disk drive 341, magnetic media drive 342, and optical media drive 343 are connected to the system bus 302 by one or more media interfaces 340 (only one shown). The drives and their associated computer-readable media provide both volatile and nonvolatile storage of computer readable instructions, data structures, program modules and other data for the personal computer 300.

Although the exemplary environment described herein employs a hard disk 341, a removable magnetic disk 342 and a removable optical disk 343, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk 341, magnetic disk 342, optical disk 343, ROM 311 or RAM 312, including an operating system, one or more application programs, other program modules, and program data, all of which are not shown). A user may enter commands and information into the personal computer 300 through input devices such as a keyboard 321 and pointing device 322. Other input devices (not shown) may include a microphone, joystick, game pad, satellite dish, scanner, or the like. These and other input devices are often connected to the processing unit 301 through an input interface 320 that is coupled to the system bus 302. The input interface 320 may be a serial port, a parallel port, a game port, a universal serial bus (USB) or any other interface. A monitor 231 or other type of display device may also be connected to the system bus 302 via an interface, such as a video interface 330. One or more speakers 351 may also be connected to the system bus 302 via an interface, such as an output peripheral interface 250. In addition to the monitor and speakers, a personal computer 300 typically includes other peripheral output devices, such as printer 370 which is described in greater detail below.

The personal computer 300 may operate in a networked environment using logical connections to one or more remote computers, via a network 362. The network 362 may be connected to other personal computers, a server, a router, a network PC, a peer device or other common network node, and typically includes many or all of the elements described above relative to the personal computer 300, although only a print server 363 has been illustrated in FIG. 3. The logical connections depicted in FIG. 3 include a local area network (LAN) 360 but may also be a wide area network (WAN—not shown). Such networking environments are commonplace in offices, enterprise-wide computer networks, intranets and the Internet.

When used in a LAN networking environment, the personal computer 300 is connected to the local network 362 through the network interface or adapter 335. When used in a WAN networking environment, the personal computer 300 typically includes a modem 355 or other means for establishing communications over the wide area network, such as the Internet. The modem 355, which may be internal or external, is connected to the system bus 302 via the input interface 320. It will be appreciated that the network connections shown are exemplary and other means of establishing a communications link between the computers and printers may be used.

The general computing environment of FIG. 3 provides for interfacing a printer 200 generally constructed according to various embodiments of the invention. The printer 200 of FIG. 2 is also shown in FIG. 3 and is coupled to the personal computer 300 via an output peripheral interface 350. The printer 200 is also shown as connected to the print server 363 which may also relay communications from the personal computer via the network 362. In either communication connection example, the personal computer 300 is able to generate a print job which may be communicated to the controller 290 of the printer 200 in its original form.

In one embodiment of the invention, all processing of the print job is accomplished at the printer 200. In this manner, a print job generated from the personal computer 300 having a format typically suitable for plain or white media may be communicated to the printer 200. When the print job is received at the controller 290, it may be stored in the printing buffer 297, while the media 298 currently in the media tray 280 is being analyzed. Thus, after the print job is received and stored, the media analysis device 299 may analyze the media 298 to determine one or more characteristics of the media 298. This information is then communicated to the controller 290 and then processed and assimilated by the print job modification component 289. Once assimilated, i.e., the print job is modified/adjusted according the determined characteristics of the media 298, the printer 200 may then proceed with the printing of the print job in the modified format.

Other embodiments of the invention, however, may process the adjustments in a different processor (i.e., not the controller 290) away from the printer 200. For example, the print server 363 may coordinate the processing of adjustments using a local print job modification component 364 based on the media analysis at the printer 200. Thus, the print job may be stored at the print server 363 while the media analysis device 299 analyzes the media 298. Then the determined characteristics may be communicated to the print server 363 and the print server 363 may modify the print job before passing it along to the printer 200 for printing. In yet another embodiment, the processing of the modification may be processed at the personal computer 300, or at another computer connected to the network 362. In any case, the processing need not be accomplished at the printer 200, such that the printer 200 when receiving a print job may process the print job normally, i.e., assume that any all modifications have already been made and that the print job, when sent to the printer 200 may be printed directly.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

I claim:

1. A printer, comprising:
a controller operable to receive a signal representing a print job, the controller operable to interpret the signal into command signals for printing the print job to media;
a media analysis device operable to analyze a characteristic of the media to which the print job is printed; and
a print job modification component coupled to the controller and to the media analysis device, the print job modification component operable to modify the print job in response to the analysis of the media.

2. The printer of claim 1 wherein the media comprises paper having a non-white color.

3. The printer of claim 1 wherein the media analysis device comprises a calorimeter operable to determine the color of the media.

4. The printer of claim 1 wherein the printer comprises a laser printer.

5. The printer of claim 1 wherein the print job modification component is operable to modify the print job in a first manner if the print job is a textual print job and operable to modify the print job in a second manner if the print job is a photo print job.

6. The printer of claim 1, wherein the print job comprises a format of one of the group comprising: RGB, CMYK, and Pantone.

7. A method for printing to media, the method comprising:
receiving a request to print a document, the document comprising a first print format;
in response to the request to print, analyzing a media in which the printed page is to be printed to determine a characterization;
modifying the print format of the document based on the determined characterization; and
printing the document to the media based on the modified print format.

8. The method of claim 7, further comprising:
in response to analyzing the media, sending a signal to a processing unit coupled to the printer via a network, the signal representing the document and the characterization of the media, and
modifying the print format of the document at the processing unit to yield the modified print format, and
sending the document having the modified print format back to the printer.

9. The method of claim 7 wherein the analyzing further comprises determining a characteristic of the media from the group comprising: color intensity, glossiness, thickness, paper quality, transparency, texture, reflectivity, and size.

10. The method of claim 7, further comprising:
determining a color intensity of the media such the color intensity is represented as a discrete intensity among a plurality of discrete intensity values;
based on the determined color intensity, adjusting at least one color of a plurality of colors in the print format of the document.

11. The method of claim 10 wherein the adjusting further comprises adjusting a color in the print format of the document most closely associated with the determined color intensity of the media.

12. The method of claim 10 wherein the adjusting comprises adjusting a color in the print format of the document according to a predetermined algorithm.

13. The method of claim 7 further comprising adjusting in a first manner if the printed page is textual and in a second manner if the printed page is photographical.

14. A computer-network implemented printing system comprising:
a printer including:
a controller operable to receive a signal representing a print job, the controller operable to interpret the signal into command signals for printing the print job to media; and
a media analysis device operable to analyze a characteristic of the media to which the print job is printed;
a computer coupled to the printer and operable to generate the signal representing the print job to be printed at the printer; and
a print job modification component coupled to the controller and to the media analysis device, the print job adjustment component operable to modify the print job in response to the analysis of the media.

15. The computer-network implemented printing system of claim 14 wherein the print job modification component comprises a component within the printer.

16. The computer-network implemented printing system of claim 14 wherein the print job modification component comprises a component within the computer.

17. The computer-network implemented printing system of claim 14 wherein the print job modification component comprises a component coupled to the computer and the printer via a network connection.

18. The computer-network implemented printing system of claim 14, further comprising a printer server coupled to the printer and coupled to the computer, the printer server operable to coordinate and distribute print jobs generated by the computer, the printer server including the print job modification component.

19. The computer-network implemented printing system of claim 14, further comprising a server computer coupled to the printer and coupled to the computer, the server computer operable to coordinate and distribute print jobs generated by the computer, the server computer including the print job modification component.

20. The computer-network implemented printing system of claim 14 wherein the printer comprises one of the group including: a laser printer and an inkjet printer.
